(19) United States
(12) Patent Application Publication
(10) Pub. No.: US 2022/0320972 A1
(43) Pub. Date: Oct. 6, 2022

(54) ROTARY ELECTRIC DEVICE

(71) Applicant: HONDA MOTOR CO., LTD., Tokyo (JP)

(72) Inventor: Manabu Yatsurugi, Wako-shi (JP)

(21) Appl. No.: 17/674,872

(22) Filed: Feb. 18, 2022

(30) Foreign Application Priority Data
Mar. 31, 2021 (JP) 2021-060467

(51) Int. Cl. H02K 11/33; H02K 1/16; H02K 3/48

(52) U.S. Cl. CPC H02K 11/33; H02K 1/16; H02K 3/48

(57) ABSTRACT

A rotary electric device includes a first inverter circuit and a second inverter circuit which control the driving of a motor, and the driving of the motor is controlled by setting a phase of a carrier frequency of the first inverter circuit and a phase of a carrier frequency of the second inverter circuit as opposite phases. The motor includes a stator which includes a plurality of slots, a plurality of coils each of which is inserted into each of the plurality of slots, and a rotor which is provided to be rotatable relative to the stator. In the plurality of coils, one first coil connected to the first inverter circuit and one second coil connected to the second inverter circuit constitute one coil pair, and at least one coil pair is disposed in one slot.

### CROSS-REFERENCE TO RELATED APPLICATION

Priority is claimed on Japanese Patent Application No. 2021-060467, filed on Mar. 31, 2021, the contents of which are incorporated herein by reference.

### BACKGROUND

### Field of the Invention

The present invention relates to a rotary electric device.

### Background

As a rotary electric device, a rotary electric device including a rotary electric machine and an inverter circuit (inverter device) controlling the driving of the rotary electric machine is known. As the rotary electric machine, a rotary electric machine including a stator provided with a plurality of slots and a rotor provided to be rotatable relative to the stator and having a magnet is known.

A plurality of coils is inserted into the plurality of slots. When these coils are energized, an interlinkage magnetic flux is formed in the stator. A magnetic attraction or repulsion is generated between this interlinkage magnetic flux and the magnet of the rotor, and the rotor is continuously rotated. The energization control to the coil is performed by the inverter circuit.

Here, harmonic components that do not contribute to the rotational torque of the rotor are superimposed on the output current to the coil due to the configuration of the rotary electric machine and the configuration of the inverter circuit. Therefore, since the vibration (torque ripple) of the rotary electric machine increases, various techniques for reducing the influence of harmonic components have been proposed.

For example, a technique has been proposed in which inverter circuits are duplicated in parallel and the phases of these carrier frequencies are reversed (inverted) (see, for example, Japanese Unexamined Patent Application, First Publication No. 2012-239346). With such a configuration, the harmonic components on the power supply system side generated in the motor connected to each inverter circuit cancel each other and the harmonic components are reduced.

### SUMMARY

However, in the above-described conventional technique, the connection structure of each coil to each inverter circuit is unknown and the arrangement of each coil in each slot is unknown. Therefore, it is difficult to say that the harmonic component can be reliably reduced and the vibration of the rotary electric machine can be reduced.

An aspect of the present invention is to provide a rotary electric device capable of reliably reducing a harmonic component and reducing a vibration of a rotary electric machine.

A rotary electric device according to an aspect of the present invention includes: a rotary electric machine; and a first inverter circuit and a second inverter circuit which control a driving of the rotary electric machine, wherein the driving of the rotary electric machine is controlled by setting a phase of a carrier frequency of the first inverter circuit and a phase of a carrier frequency of the second inverter circuit as opposite phases, wherein the rotary electric machine includes a stator which includes a plurality of slots, a plurality of coils each of which is inserted into each of the plurality of slots, and a rotor which is provided to be rotatable relative to the stator, wherein in the plurality of coils, one first coil connected to the first inverter circuit and one second coil connected to the second inverter circuit constitute one coil pair, and wherein at least one coil pair is disposed in one of the plurality of slots.

With such a configuration, two coils with opposite phase carrier frequencies exist in a pair in one slot. Therefore, the harmonic components due to the magnetomotive forces of two paired coils cancel each other and this harmonic component can be reliably reduced. Thus, the vibration of the rotary electric machine can be reduced.

In the above-described configuration, the plurality of slots may have a common mode coil slot in which only the coil pair of the same phase is disposed.

Since the coils of the same phase have the same energization timing, it is possible to more reliably reduce the harmonic component due to the magnetomotive force of each coil arranged in the common mode coil slot.

In the above-described configuration, at least two coil pairs may be arranged in the common mode coil slot, and the first coil and the second coil may be alternately arranged.

With such a configuration, since the first coil and the second coil are arranged alternately, it is possible to more reliably cancel the harmonic components due to the magnetomotive force of each coil. Therefore, it is possible to more reliably reduce the harmonic component of each coil.

In the above-described configuration, the common mode coil slot may be arranged every other slot.

With such a configuration, since the slots with reliably reduced harmonic components are arranged every other slot, it is possible to reduce the harmonic component in a well-balanced manner in the whole rotary electric machine and to more reliably cancel the harmonic components due to the magnetomotive forces of the coils.

According to an aspect of the present invention, it is possible to cancel the harmonic components due to the magnetomotive forces of the two paired coils and to reliably reduce this harmonic component. Therefore, it is possible to reduce the vibration of the rotary electric machine.

### BRIEF DESCRIPTION OF THE DRAWINGS

FIG. 1 is a circuit diagram of a rotary electric device of an embodiment of the present invention.

FIG. 2 is an enlarged cross-sectional view showing a configuration of a part of a motor of the embodiment.

FIG. 3 is a diagram showing a waveform of a carrier frequency of each inverter circuit of the embodiment.

FIG. 4A is an explanatory diagram of the arrangement of each phase coil in each slot of the embodiment.

FIG. 4B is an explanatory diagram of the arrangement of each phase coil in each slot of the embodiment.

FIG. 4C is an explanatory diagram of the arrangement of each phase coil in each slot of the embodiment.

FIG. 5 is a partially enlarged view showing the arrangement of each phase coil shown in FIGS. 4A to 4C for each connected inverter circuit.

FIG. 6 is a graph showing a comparison between the loss of the motor of the embodiment and the loss of the conventional motor.

FIG. 7 is a graph showing a comparison between a torque ripple of the motor of the embodiment and a torque ripple of the conventional motor.

FIG. 8A is an explanatory diagram of the arrangement of each phase coil in each slot of a first modified example of the embodiment.

FIG. 8B is an explanatory diagram of the arrangement of each phase coil in each slot of the first modified example of the embodiment.

FIG. 8C is an explanatory diagram of the arrangement of each phase coil in each slot of the first modified example of the embodiment.

FIG. 9A is an explanatory diagram of the arrangement of each phase coil in each slot of a second modified example of the embodiment.

FIG. 9B is an explanatory diagram of the arrangement of each phase coil in each slot of the second modified example of the embodiment.

FIG. 9C is an explanatory diagram of the arrangement of each phase coil in each slot of the second modified example of the embodiment.

FIG. 10A is an explanatory diagram of the arrangement of each phase coil in each slot of a third modified example of the embodiment.

FIG. 10B is an explanatory diagram of the arrangement of each phase coil in each slot of the third modified example of the embodiment.

FIG. 10C is an explanatory diagram of the arrangement of each phase coil in each slot of the third modified example of the embodiment.

### DESCRIPTION OF EMBODIMENTS

Next, an embodiment of the present invention will be described with reference to the drawings.

<Rotary Electric Device>

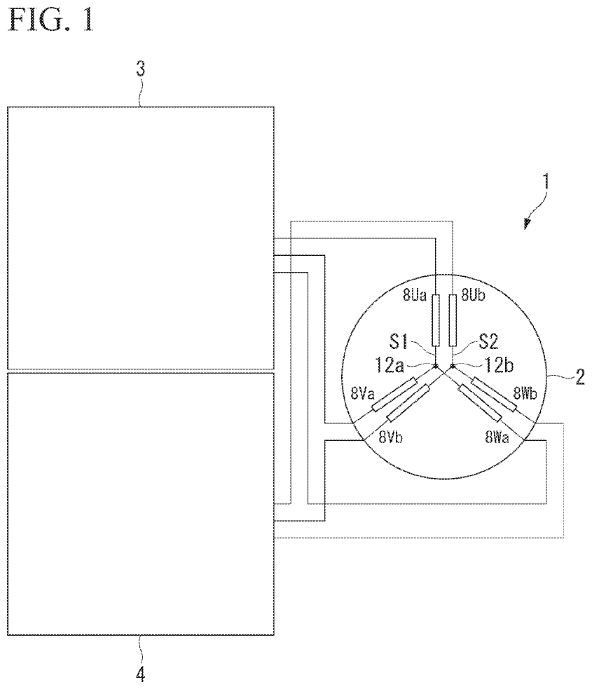

FIG. 1 is a circuit diagram of a rotary electric device 1.

As shown in FIG. 1, the rotary electric device 1 includes a motor 2 which is a rotary electric machine and first and second inverter circuits 3 and 4 which control the driving of the motor 2.

The rotary electric device 1 is mounted on a vehicle such as an electric vehicle. The electric vehicle is an electric automobile, a hybrid vehicle, a fuel cell vehicle, or the like. The electric automobile is driven by using a battery as a power source. The hybrid vehicle is driven by using a battery and an internal combustion engine as a power source. The fuel cell vehicle is driven by using a fuel cell as a power source. The motor 2 generates a rotational driving force by the electric power supplied from the battery at the time of driving.

<Motor>

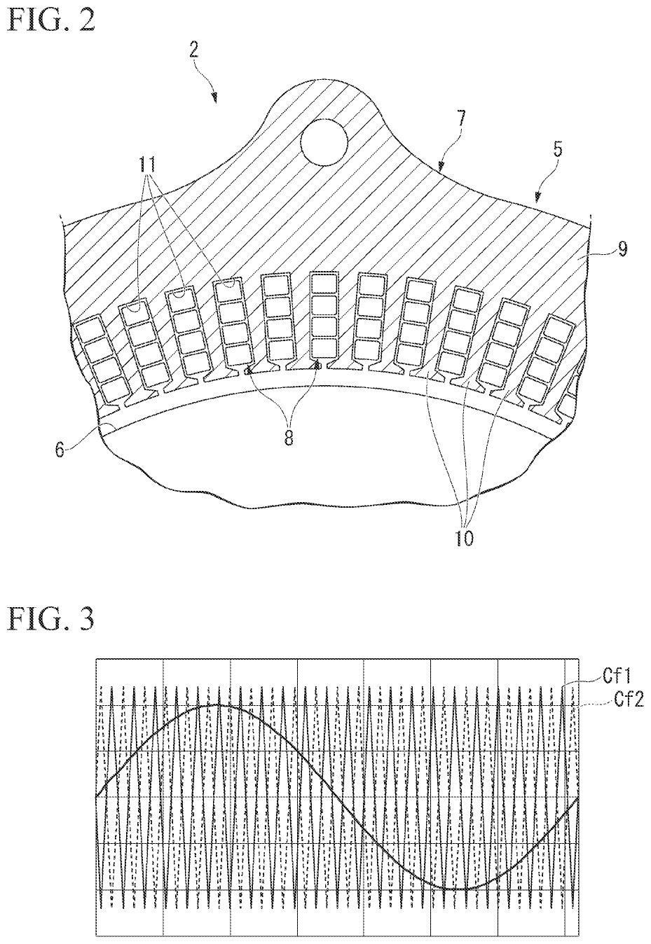

FIG. 2 is an enlarged cross-sectional view showing a configuration of part of the motor 2. Hereinafter, the rotation axis direction of the motor 2 will be simply described as the axial direction, the rotation direction will be simply described as the circumferential direction, and the direction orthogonal to the axial direction and the circumferential direction will be simply described as the radial direction.

As shown in FIGS. 1 and 2, the motor 2 is a three-phase (U-phase, V-phase, and W-phase) motor. The motor 2 includes a cylindrical stator 5 and a rotor 6 which is disposed on the inside of the stator 5 in the radial direction and is supported by the stator 5 to be rotatable. A plurality of magnets (not shown) are provided on the outer peripheral portion of the rotor 6. In this embodiment, the number of magnetic poles of the magnet is composed of eight poles.

The stator 5 includes a cylindrical stator core 7 and a plurality of coils 8 which are attached to the stator core 7. The stator core 7 can be formed, for example, by laminating electromagnetic steel sheets or pressure-molding soft magnetic powder. The stator core 7 is integrally formed with a cylindrical yoke portion 9 and a plurality of (for example, in this embodiment, forty eight) teeth portions 10 which protrude radially inward from the inner peripheral surface of the yoke portion 9.

Each slot 11 is formed between the teeth portions 10 which are adjacent to each other in the circumferential direction. The slot 11 is a so-called open slot, which penetrates the stator core 7 in the axial direction and is open inward in the radial direction. A plurality of (in this embodiment, four) coils 8 of each phase are inserted to be arranged on each slot 11 in the radial direction. In the following description, in order for the clear description, the coils 8 arranged on each slot 11 may be referred to as a first layer coil 8, a second layer coil 8, a third layer coil 8, and a fourth layer coil 8 in order from the outside in the radial direction.

The coil 8 has a three-phase structure (U-phase coils 8Ua and 8Ub, V-phase coils 8Va and 8Vb, and W-phase coils 8Wa and 8Wb). The three-phase coils 8Ua to 8Wb are connected to form two start connection (Y-connection) circuits S1 and S2 (a first star connection circuit S1 and a second star connection circuit S2) having neutral points 12a and 12b (first and second neutral points 12a and 12b).

In the first phase coils 8Ua to 8Wa constituting the first star connection circuit S1 in two star connection circuits S1 and S2, the terminal portions on the side opposite to the first neutral point 12a are connected to the first inverter circuit 3. In the second phase coils 8Ub to 8Wb constituting the second star connection circuit S2 in two star connection circuits S1 and S2, the terminal portions on the side opposite to the second neutral point 12b are connected to the second inverter circuit 4.

<Inverter Circuit>

Each of the inverter circuits 3 and 4 is, for example, a three-phase bridge circuit including a plurality of switching elements (not shown). Each of the inverter circuits 3 and 4, for example, controls external power (not shown) by pulse width modulation (PWM) control of the plurality of switching elements, and selectively outputs them to each phase coil 8Ua to 8Wb.

FIG. 3 is a diagram showing waveforms of carrier frequencies Cf1 and Cf2 of the inverter circuits 3 and 4.

As shown in FIG. 3, the phase of the first carrier frequency Cf1 of the first inverter circuit 3 and the phase of the second carrier frequency Cf2 of the second inverter circuit 4 are opposite phases. In this way, the circuit for controlling the driving of the motor 2 is operated by parallel duplicating two inverter circuits 3 and 4, and the phases of the carrier frequencies Cf1 and Cf2 are opposite to each other.

<Coil Arrangement Structure>

Next, the arrangement structure of the coil 8 will be described.

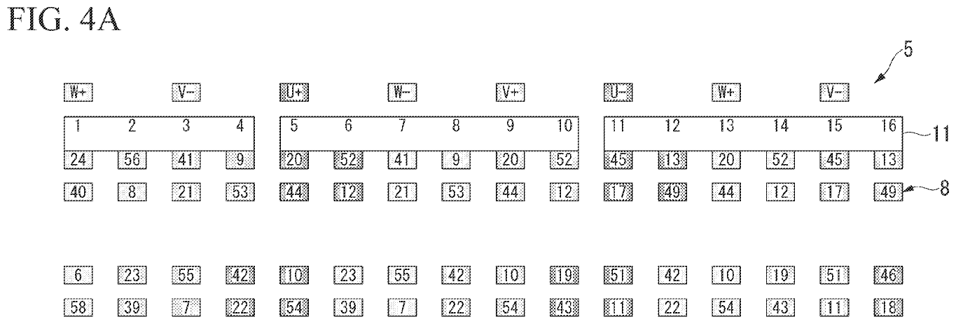

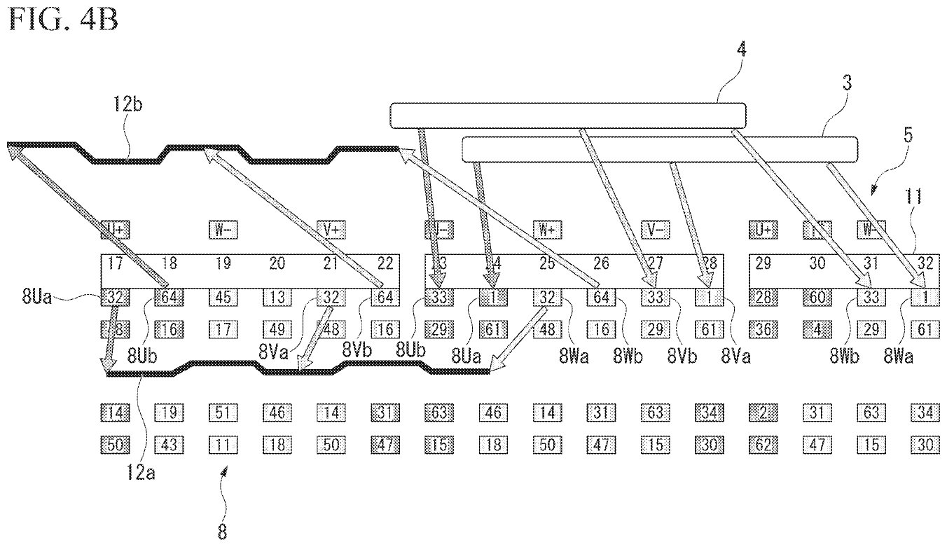

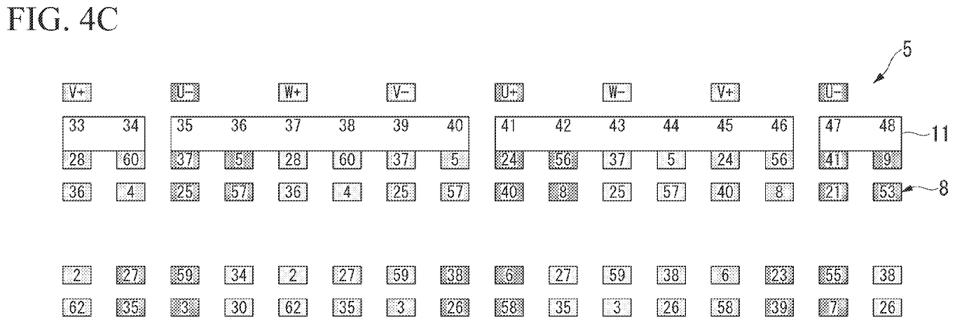

FIGS. 4A, 4B, and 4C are explanatory diagrams of the arrangement of each of the phase coils Ua to Wb in each slot 11 and are development views of the stator 5. In order for the clear description, FIGS. 4A to 4C show one stator 5.

In FIGS. 4A to 4C, the circumferential direction of the stator 5 is the traverse direction and the radial direction of the stator 5 is the longitudinal direction. In FIGS. 4A to 4C, the upper side is the outside of the radial direction and the lower side is the inside of the radial direction.

Further, in FIGS. 4A to 4C, each slot 11 is numbered in order in the circumferential direction and each coil 8 (each of the phase coils 8Ua to 8Wb) is numbered in order from the inverter circuits 3 and 4 toward the neutral points 12a and 12b.

Further, in FIGS. 4A to 4C, the symbol for each phase above the slot 11 indicates the winding direction of the coil 8 between the corresponding slots 11. For example, if a case in which the U-phase coils 8Ua and 8Ub are wound in one direction between the corresponding slots 11 is referred to as “U+”, a case in which the U-phase coils are wound in the direction opposite to one direction is referred to as “U−”. The same applies to the V-phase coils 8Va and 8Vb and the W-phase coils 8Wa and 8Wb. The winding direction of the coil 8 between the slots 11 becomes the winding direction shown in FIGS. 4A to 4C when the coils 8 are connected in series in numerical order.

More specifically, as shown in FIGS. 4A to 4C, the first U-phase coil 8Ua (the first coil) at the first location inserted into the 24th slot 11 is connected to the first U-phase coil 8Ua at the second location inserted into the 29th slot 11 with four slots 11 therebetween. The first U-phase coil 8Ua at the first location is disposed closer to the outermost peripheral portion (first layer) of four coils 8 inserted into the 24th slot 11. The first U-phase coil 8Ua at the second location is disposed at the third portion (third layer) from the outermost peripheral portion in four coils 8 inserted into the 29th slot 11.

This is connected to the remaining coils in order from the first U-phase coil 8Ua at the third location to the first U-phase coil 8Ua at the 32nd location. The terminal portion on the side opposite to the first U-phase coil 8Ua at the second location in the first U-phase coil 8Ua at the first location is connected to the first inverter circuit 3. In the first U-phase coil 8Ua at the 32nd location inserted into the 17th slot 11, the terminal portion on the side opposite to the first U-phase coil 8Ua at the 31st location inserted into the 22nd slot 11 is connected to the first neutral point 12a. The first U-phase coil 8Ua at the first location to the first U-phase coil 8Ua at the 32nd location constitute the first star connection circuit S1 (see FIG. 1).

Similarly, a connection is performed in order from the first V-phase coil 8Va (first coil) at the first location inserted into the 28th slot 11 to the first V-phase coil 8Va at the 32nd location inserted into the 21st slot 11. In the first V-phase coil 8Va at the first location, the terminal portion on the side opposite to the first V-phase coil 8Va at the second location inserted into the 33rd slot 11 is connected to the first inverter circuit 3. In the first V-phase coil 8Va at the 32nd location, the terminal portion on the side opposite to the first V-phase coil 8Va at the 31st location inserted into the 26th slot 11 is connected to the first neutral point 12a. The first V-phase coil 8Va at the first location to the first V-phase coil 8Va at the 32nd location constitute the first star connection circuit S1 (see FIG. 1).

Further, a connection is performed in order from the first W-phase coil 8Wa (first coil) at the first location inserted into the 32nd slot 11 to the first W-phase coil 8Wa at the 32nd location inserted into the 25th slot 11. In the first W-phase coil 8Wa at the first location, the terminal portion on the side opposite to the first W-phase coil 8Wa at the second location inserted into the 37th slot 11 is connected to the first inverter circuit 3. In the first W-phase coil 8Wa at the 32nd location, the terminal portion on the side opposite to the first W-phase coil 8Wa at the 31st location inserted into the 30th slot 11 is connected to the first neutral point 12a. The first W-phase coil 8Wa at the first location to the first W-phase coil 8Wa at the 32nd location constitute the first star connection circuit S1 (see FIG. 1).

On the other hand, the second U-phase coil 8Ub (second coil) at the 33rd location inserted into the 23rd slot 11 is connected to the second U-phase coil 8Ub at the 34th location inserted into the 28th slot 11 with four slots 11 therebetween. The second U-phase coil 8Ub at the 33rd location is disposed closer to the outermost peripheral portion (first layer) in four coils 8 inserted into the 23rd slot 11. The second U-phase coil 8Ub at the 34th location is disposed at the third portion (third layer) from the outermost peripheral portion in four coils 8 inserted into the 34th slot 11.

This is connected to the remaining coils in order from the second U-phase coil 8Ub at the 35th location to the second U-phase coil 8Ub at the 64th location. The terminal portion on the side opposite to the second U-phase coil 8Ub at the 34th location in the second U-phase coil 8Ub at the 33rd location is connected to the second inverter circuit 4. In the second U-phase coil 8Ub at the 64th location inserted into the 18th slot 11, the terminal portion on the side opposite to the second U-phase coil 8Ub at the 63rd location inserted into the 23rd slot 11 is connected to the second neutral point 12b. The second U-phase coil 8Ub at the 33rd location to the second U-phase coil 8Ub at the 64th location constitute the second star connection circuit S2 (see FIG. 1).

Similarly, a connection is performed in order from the second V-phase coil 8Vb (second coil) at the 33rd location inserted into the 27th slot 11 to the second V-phase coil 8Vb at the 64th location inserted into the 22nd slot 11. In the second V-phase coil 8Vb at the 33rd location, the terminal portion on the side opposite to the second V-phase coil 8Vb at the 34th location inserted into the 32nd slot 11 is connected to the second inverter circuit 4. In the second V-phase coil 8Vb at the 64th location, the terminal portion on the side opposite to the second V-phase coil 8Vb at the 63rd location inserted into the 27th slot 11 is connected to the second neutral point 12b. The second V-phase coil 8Vb at the 33rd location to the second V-phase coil 8Vb at the 64th location constitute the second star connection circuit S2 (see FIG. 1).

Further, a connection is performed in order from the second W-phase coil 8Wb (second coil) at the 33rd location inserted into the 31st slot 11 to the second W-phase coil 8Wb at the 64th location inserted into the 26th slot 11. In the second W-phase coil 8Wb at the 33rd location, the terminal portion on the side opposite to the second W-phase coil 8Wb at the 34th location inserted into the 36th slot 11 is connected to the second inverter circuit 4. In the second W-phase coil 8Wb at the 64th location, the terminal portion on the side opposite to the second W-phase coil 8Wb at the 63rd location inserted into the 31st slot 11 is connected to the second neutral point 12b. The second W-phase coil 8Wb at the 33rd location to the second W-phase coil 8Wb at the 64th location constitute the second star connection circuit S2 (see FIG. 1).

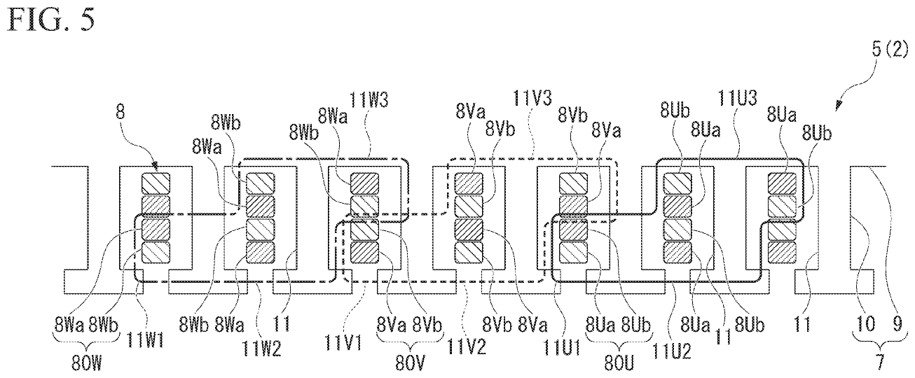

FIG. 5 is a partially enlarged view showing the arrangement of each phase coil 8 shown in FIGS. 4A to 4C for each of the connected inverter circuits 3 and 4. The stator 5 of FIG. 5 corresponds to the stator 5 of FIGS. 4A to 4C above.

As shown in FIG. 5, the phase coils 8Ua to 8Wb are respectively arranged on three slots 11 arranged in the circumferential direction. When three slots 11 are set to first slots 11U1 to 11W1, second slots 11U2 to 11W2, and third slots 11U3 to 11W3 in order for each phase, two coils 8 (the coils 8 on the third layer and the fourth layer) on the inside of the radial direction in the first slots 11U1 to 11W1 in four coils 8 arranged in the radial direction are the coils 8 of the corresponding phases. These two coils 8 are composed of one of the first phase coils 8Ua to 8Wa connected to the first inverter circuit 3 and one of the second phase coils 8Ub to 8Wb connected to the second inverter circuit 4.

Hereinafter, such a pair composed of one of the first phase coils 8Ua to 8Wa connected to the first inverter circuit 3 and one of the second phase coils 8Ub to 8Wb connected to the second inverter circuit 4 is referred to as coil pairs 80U, 80V, and 80W. That is, one U-phase coil pair 80U is disposed in the U-phase first slot 11U1. One V-phase coil pair 80V is disposed in the V-phase first slot 11V1. One W-phase coil pair 80W is disposed in the W-phase first slot 11W1.

In the second slots 11U2 to 11W2, all of four coils 8 (the coils 8 of the first layer to the fourth layer) arranged in the radial direction are the coils 8 of the corresponding phase. The second slots 11U2 to 11W2 in which all of four coils 8 arranged in this way are in the same phase correspond to common mode coil slots. Four coils 8 of the second slots 11U2 to 11W2 are composed of two coil pairs 80U to 80W. In two coil pairs 80U to 80W, the first phase coils 8Ua to 8Wa connected to the first inverter circuit 3 and the second phase coils 8Ub to 8Wb connected to the second inverter circuit 4 are alternately arranged.

In the third slots 11U3 to 11W3, two coils 8 (the coils 8 of the first layer and the second layer) on the outside of the radial direction in four coils 8 arranged in the radial direction are the coils 8 of the corresponding phase. These two coils 8 are one coil pair 80U to 80W.

In this way, the phase coils 8Ua to 8Wb respectively disposed in the slots 11U1 to 11W3 are further sequentially arranged in the circumferential direction. For example, in FIG. 5, the W phase, the V phase, and the U phase are sequentially arranged. Then, the phase coils 8Ua to 8Wb are arranged so that the W-phase third slot 11W3 and the V-phase first slot 11V1 are the same slot 11. The phase coils 8Ua to 8Wb are arranged so that the V-phase third slot 11V3 and the U-phase first slot 11U1 are the same slot 11. The phase coils 8Ua to 8Wb are arranged so that the U-phase third slot 11U3 and the W-phase first slot 11W1 are the same slot 11.

Accordingly, the second slots (common mode coil slots) 11U2 to 11W2 of each phase are arranged every other slot 11 (the slot 11 in which the first slots 11U1 to 11W1 and the third slots 11U3 to 11W3 are mixed).

<Operation of Rotary Electric Device>

Next, the operation of the rotary electric device 1 will be described.

When driving the motor 2 of the rotary electric device 1, external power (not shown) is controlled by using two inverter circuits 3 and 4 (see FIG. 1) and is selectively output to each of the phase coils 8Ua to 8Wb. At this time, the inverter circuits 3 and 4 respectively output the carrier frequencies Cf1 and Cf2 to the phase coils 8Ua to 8Wb in the same phase at the same energization timing. At this time, the phases of the carrier frequencies Cf1 and Cf2 output to the phase coils 8Ua to 8Wb in the same phase are opposite phases (see FIG. 3).

When power is supplied to each of the phase coils 8Ua to 8Wb, the stator 5 forms a constant interlinkage magnetic flux. A magnetic attraction or repulsion is generated between this interlinkage magnetic flux and a magnet (not shown) of the rotor 6, and the rotor 6 is continuously rotated.

Here, all of the phase coils 8Ua to 8Wb inserted into the slots 11 of the stator 5 constitute the coil pair 80U to 80W. As described above, the carrier frequencies Cf1 and Cf2 having the opposite phases are output to the phase coils 8Ua to 8Wb in the same phase at the same energization timing. Therefore, in the coil pair 80U to 80W, the harmonic components due to the magnetomotive forces of the phase coils 8Ua to 8Wb constituting the coil pair 80U to 80W cancel each other and the harmonic components are reduced.

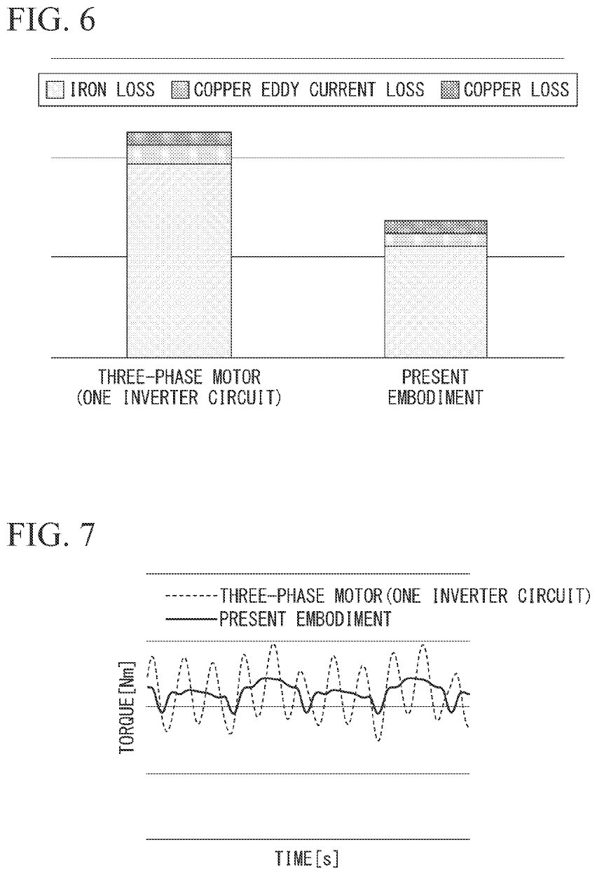

FIG. 6 is a graph comparing the losses when the three-phase motor is driven by one inverter circuit and is driven in this embodiment. Additionally, the loss refers to the iron loss of the stator 5 and the eddy current loss (copper eddy loss) and the copper loss of the coil 8.

As shown in FIG. 6, it can be confirmed that the iron loss of the stator 5 and the eddy current loss of the coil 8 can be reduced in this embodiment as compared with the case in which the three-phase motor is driven by one inverter circuit. In particular, it can be confirmed that the iron loss of the stator 5 can be significantly reduced.

FIG. 7 is a graph showing a change in torque (torque ripple) when the vertical axis is torque and the horizontal axis is elapsed time (time) [S] and the loss is compared between the case of driving with one inverter circuit and the case of driving with this embodiment.

As shown in FIG. 7, it can be confirmed that the torque ripple of the motor can be significantly reduced in this embodiment as compared with the case in which the three-phase motor is driven by one inverter circuit.

In this way, in the above-described embodiment, in the phase coils 8Ua to 8Wb, one of the first phase coils 8Ua to 8Wa connected to the first inverter circuit 3 and one of the second phase coils 8Ub to 8Wb connected to the second inverter circuit 4 constitute one coil pair 80U to 80W. Then, two coil pairs 80U to 80W are arranged in one slot 11. That is, the phase coils 8Ua to 8Wb arranged in one slot 11 essentially constitute the coil pair 80U to 80W. Under such a configuration, the first carrier frequency Cf1 output to each of the first phase coils 8Ua to 8Wa and the second carrier frequency Cf2 output to each of the second phase coils 8Ub to 8Wb are opposite phases. Therefore, the harmonic components of the paired phase coils 8Ua to 8Wb cancel each other due to the magnetomotive forces, and the harmonic components can be reliably reduced. Therefore, the vibration (torque ripple) of the motor 2 can be reduced.

Further, the plurality of slots 11 include the second slots (common mode coil slot) 11U2 to 11W2 in which only the coil pair 80U to 80W of the same phase is disposed. Since the coils 8Ub to 8Wb of the same phase have the same energization timing, it is possible to more reliably reduce the harmonic component due to the magnetomotive force of each of the phase coils 8Ua to 8Wb arranged in the second slots 11U2 to 11W2.

Further, in the coil pair 80U to 80W disposed in the second slots 11U2 to 11W2, the first phase coils 8Ua to 8Wa and the second phase coils 8Ub to 8Wb are alternately arranged. Since the first phase coils 8Ua to 8Wa and the second phase coils 8Ub to 8Wb are alternately arranged, it is possible to more reliably cancel the harmonic components due to the magnetomotive forces of the coils 8Ua to 8Wb of each phase. Therefore, it is possible to more reliably reduce the harmonic component due to the magnetomotive force of the coils 8Ua to 8Wb of each phase.

Further, the second slots 11U2 to 11W2 of each phase are arranged every other slot 11. Since the second slots 11U2 to 11W2 in which the harmonic components are reliably reduced are arranged every other slot 11, it is possible to reduce the harmonic component in a well-balanced manner in the entire motor 2. Further, it is possible to more reliably reduce the harmonic components due to the magnetomotive forces of the phase coils 8Ua to 8Wb.

In the above-described embodiment, a case in which each of the phase coils 8Ua to 8Wb arranged in one slot 11 essentially constitutes the coil pair 80U to 80W by arranging and connecting the phase coils Ua to Wb in each slot 11 as shown in FIGS. 4A to 4C has been described. Further, a case in which the common mode coil slot exists every other slot 11 and the phase coils 8Ua to 8Wb of the common mode coil slot are formed such that the first phase coils 8Ua to 8Wa and the second phase coils 8Ub to 8Wb are alternately arranged (hereinafter, referred to as the pattern of FIG. 5) has been described. However, the present invention is not limited to the arrangement of each of the phase coils Ua to Wb shown in FIGS. 4A to 4C. Even if the phase coils Ua to Wb in each slot 11 are arranged and connected as in each modified example below, the pattern can be configured in the same manner as in FIG. 5.

### First Modified Example

<Coil Arrangement Structure>

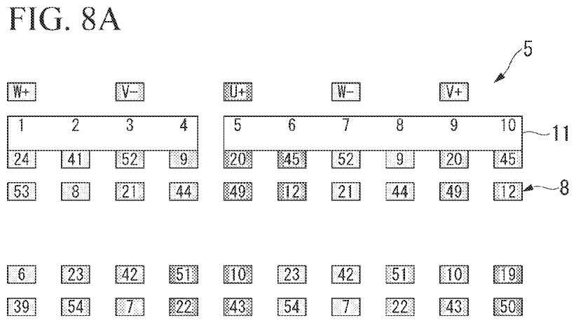

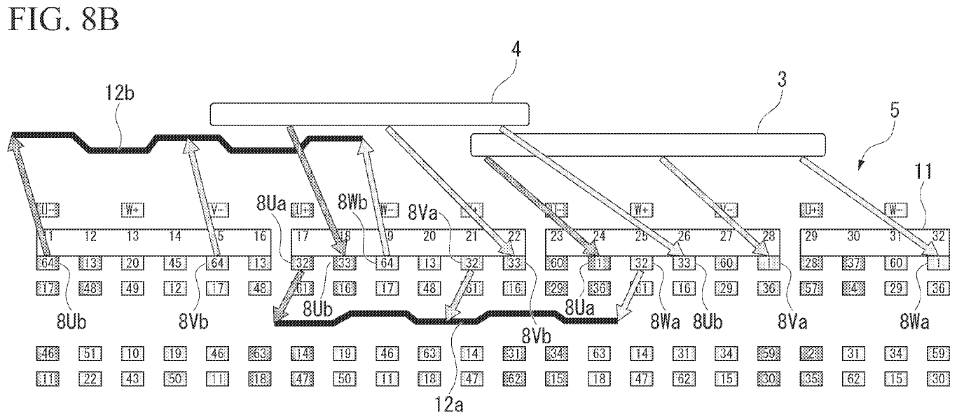

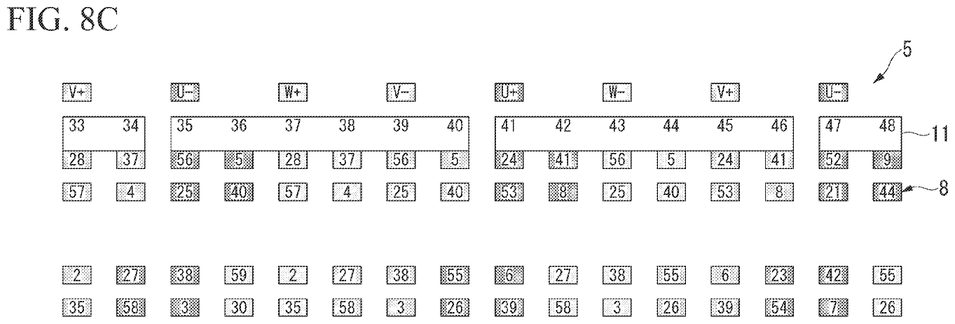

FIGS. 8A, 8B, and 8C are explanatory diagrams of each of the phase coils Ua to Wb in each slot 11 of a first modified example and are development views of the stator 5. FIGS. 8A to 8C correspond to FIGS. 4A to 4C described above. Additionally, in the following modified example, the configuration that the number of the magnetic poles of the rotor 6 is eight and the number of the slots 11 of the stator 5 is forty eight is the same as that of the above-described embodiment.

As shown in FIGS. 8A to 8C, the first U-phase coil 8Ua at the first location inserted into the 24th slot 11 is connected to the first U-phase coil 8Ua at the second location inserted into the 29th slot 11 with four slots 11 therebetween. The first U-phase coil 8Ua at the first location is disposed closer to the outermost peripheral portion (first layer) in four coils 8 inserted into the 24th slot 11. The first U-phase coil 8Ua at the second location is disposed at the third portion (third layer) from the outermost peripheral portion in four coils 8 inserted into the 29th slot 11.

This is connected to the remaining coils in order from the first U-phase coil 8Ua at the third location to the first U-phase coil 8Ua at the 32nd location. The terminal portion on the side opposite to the first U-phase coil 8Ua at the second location in the first U-phase coil 8Ua at the first location is connected to the first inverter circuit 3. In the first U-phase coil 8Ua at the 32nd location inserted into the 17th slot 11, the terminal portion on the side opposite to the first U-phase coil 8Ua at the 31st location inserted into the 22nd slot 11 is connected to the first neutral point 12a. The first U-phase coil 8Ua at the first location to the first U-phase coil 8Ua at the 32nd location constitute the first star connection circuit S1 (see FIG. 1).

Similarly, a connection is performed in order from the first V-phase coil 8Va at the first location inserted into the 28th slot 11 to the first V-phase coil 8Va at the 32nd location inserted into the 21st slot 11. In the first V-phase coil 8Va at the first location, the terminal portion on the side opposite to the first V-phase coil 8Va at the second location inserted into the 33rd slot 11 is connected to the first inverter circuit 3. In the first V-phase coil 8Va at the 32nd location, the terminal portion on the side opposite to the first V-phase coil 8Va at the 31st location inserted into the 26th slot 11 is connected to the first neutral point 12a. The first V-phase coil 8Va at the first location to the first V-phase coil 8Va at the 32nd location constitute the first star connection circuit S1 (see FIG. 1).

Further, a connection is performed in order from the first W-phase coil 8Wa at the first location inserted into the 32nd slot 11 to the first W-phase coil 8Wa at the 32nd location inserted into the 25th slot 11. In the first W-phase coil 8Wa at the first location, the terminal portion on the side opposite to the first W-phase coil 8Wa at the second location inserted into the 37th slot 11 is connected to the first inverter circuit 3. In the first W-phase coil 8Wa at the 32nd location, the terminal portion on the side opposite to the first W-phase coil 8Wa at the 31st location inserted into the 30th slot 11 is connected to the first neutral point 12a. The first W-phase coil 8Wa at the first location to the first W-phase coil 8Wa at the 32nd location constitute the first star connection circuit S1 (see FIG. 1).

On the other hand, the second U-phase coil 8Ub at the 33rd location inserted into the 22nd slot 11 is connected to the second U-phase coil 8Ub at the 34th location inserted into the 27th slot 11 with four slots 11 interposed therebetween. The second U-phase coil 8Ub at the 33rd location is disposed closer to the outermost peripheral portion (first layer) in four coils 8 inserted into the 22nd slot 11. The second U-phase coil 8Ub at the 34th location is disposed at the third portion (third layer) from the outermost peripheral portion in four coils 8 inserted into the 27th slot 11.

This is connected to the remaining coils in order from the second U-phase coil 8Ub at the 35th location to the second U-phase coil 8Ub at the 64th location. The terminal portion on the side opposite to the second U-phase coil 8Ub at the 34th location in the second U-phase coil 8Ub at the 33rd location is connected to the second inverter circuit 4. In the second U-phase coil 8Ub at the 64th location inserted into the 15th slot 11, the terminal portion on the side opposite to the second U-phase coil 8Ub at the 63rd location inserted into the 20th slot 11 is connected to the second neutral point 12b. The second U-phase coil 8Ub at the 33rd location to the second U-phase coil 8Ub at the 64th location constitute the second star connection circuit S2 (see FIG. 1).

Similarly, a connection is performed in order from the second V-phase coil 8Vb at the 33rd location inserted into the 22nd slot 11 to the second V-phase coil 8Vb at the 64th location inserted into the 15th slot 11. In the second V-phase coil 8Vb at the 33rd location, the terminal portion on the side opposite to the second V-phase coil 8Vb at the 34th location inserted into the 27th slot 11 is connected to the second inverter circuit 4. In the second V-phase coil 8Vb at the 64th location, the terminal portion on the side opposite to the second V-phase coil 8Vb at the 63rd location inserted into the 20th slot 11 is connected to the second neutral point 12b. The second V-phase coil 8Vb at the 33rd location to the second V-phase coil 8Vb at the 64th location constitute the second star connection circuit S2 (see FIG. 1).

Further, a connection is performed in order from the second W-phase coil 8Wb at the 33rd location inserted into the 26th slot 11 to the second W-phase coil 8Wb at the 64th location inserted into the 19th slot 11. In the second W-phase coil 8Wb at the 33rd location, the terminal portion on the side opposite to the second W-phase coil 8Wb at the 34th location inserted into the 31st slot 11 is connected to the second inverter circuit 4. In the second W-phase coil 8Wb at the 64th location, the terminal portion on the side opposite to the second W-phase coil 8Wb at the 63rd location inserted into the 24th slot 11 is connected to the second neutral point 12b. The second W-phase coil 8Wb at the 33rd location to the second W-phase coil 8Wb at the 64th location constitute the second star connection circuit S2 (see FIG. 1).

### Second Modified Example

<Coil Arrangement Structure>

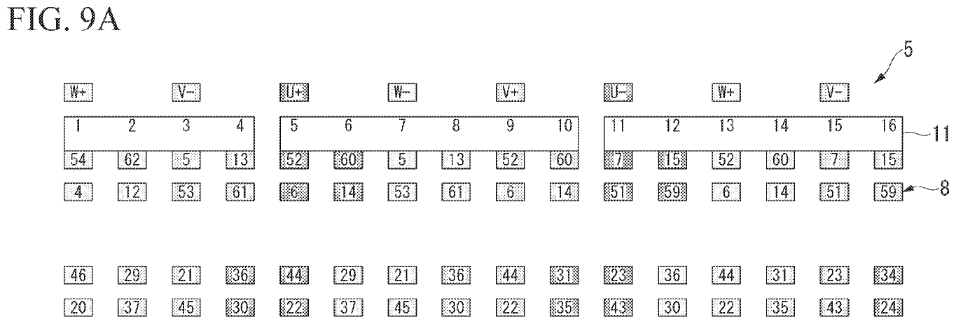

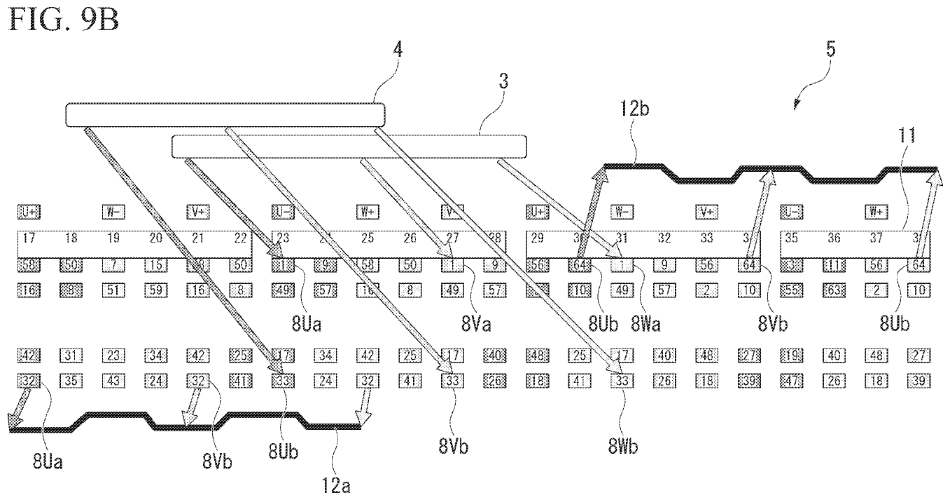

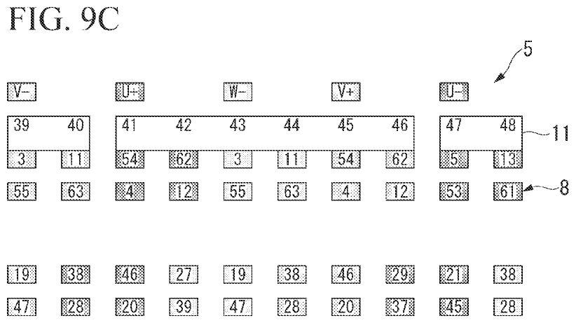

FIGS. 9A, 9B, and 9C are explanatory diagrams of the arrangement of each of the phase coils Ua to Wb in each slot 11 of a second modified example and are development views of the stator 5. FIGS. 9A to 9C correspond to FIGS. 4A to 4C described above.

As shown in FIGS. 9A to 9C, the arrangement structure of the coil 8 of the second modified example is a so-called wave winding structure. That is, the first U-phase coil 8Ua at the first location inserted into the 23rd slot 11 is connected to the first U-phase coil 8Ua at the second location inserted into the 29th slot 11 with five slots 11 therebetween. The first U-phase coil 8Ua at the first location is disposed closer to the outermost peripheral portion (first layer) in four coils 8 inserted into the 23rd slot 11. The first U-phase coil 8Ua at the second location is disposed at the second portion (second layer) from the outermost peripheral portion in four coils 8 inserted into the 29th slot 11.

This is connected to the remaining coils in order from the first U-phase coil 8Ua at the third location to the first U-phase coil 8Ua at the 32nd location. The terminal portion on the side opposite to the first U-phase coil 8Ua at the second location in the first U-phase coil 8Ua at the first location is connected to the first inverter circuit 3. In the first U-phase coil 8Ua at the 32nd location inserted into the 17th slot 11, the terminal portion on the side opposite to the first U-phase coil 8Ua at the 31st location inserted into the tenth slot 11 is connected to the first neutral point 12a. The first U-phase coil 8Ua at the first location to the first U-phase coil 8Ua at the 32nd location constitute the first star connection circuit S1 (see FIG. 1).

Similarly, a connection is performed in order from the first V-phase coil 8Va at the first location inserted into the 27th slot 11 to the first V-phase coil 8Va at the 32nd location inserted into the 21st slot 11. In the first V-phase coil 8Va at the first location, the terminal portion on the side opposite to the first V-phase coil 8Va at the second location inserted into the 33rd slot 11 is connected to the first inverter circuit 3. In the first V-phase coil 8Va at the 32nd location, the terminal portion on the side opposite to the first V-phase coil 8Va at the 31st location inserted into the 14th slot 11 is connected to the first neutral point 12a. The first V-phase coil 8Va at the first location to the first V-phase coil 8Va at the 32nd location constitute the first star connection circuit S1 (see FIG. 1).

Further, a connection is performed in order from the first W-phase coil 8Wa at the first location inserted into the 31st slot 11 to the first W-phase coil 8Wa at the 32nd location inserted into the 25th slot 11. In the first W-phase coil 8Wa at the first location, the terminal portion on the side opposite to the first W-phase coil 8Wa at the second location inserted into the 37th slot 11 is connected to the first inverter circuit 3. In the first W-phase coil 8Wa at the 32nd location, the terminal portion on the side opposite to the first W-phase coil 8Wa at the 31st location inserted into the 18th slot 11 is connected to the first neutral point 12a. The first W-phase coil 8Wa at the first location to the first W-phase coil 8Wa at the 32nd location constitute the first star connection circuit S1 (see FIG. 1).

On the other hand, the second U-phase coil 8Ub at the 33rd location inserted into the 23rd slot 11 is connected to the second U-phase coil 8Ub at the 34th location inserted into the 16th slot 11 with six slots 11 therebetween. The second U-phase coil 8Ub at the 33rd location inserted into the 23rd slot 11 is disposed closer to the innermost peripheral portion (fourth layer) in four coils 8 inserted into each slot 11. The second U-phase coil 8Ub at the 34th location inserted into the 16th slot 11 is disposed at the third portion (third layer) from the outermost peripheral portion in four coils 8 inserted into each slot 11.

This is connected to the remaining coils in order from the second U-phase coil 8Ub at the 35th location to the second U-phase coil 8Ub at the 64th location. The terminal portion on the side opposite to the second U-phase coil 8Ub at the 34th location in the second U-phase coil 8Ub at the 33rd location is connected to the second inverter circuit 4. In the second U-phase coil 8Ub at the 64th location inserted into the 30th slot 11, the terminal portion on the side opposite to the second U-phase coil 8Ub at the 63rd location inserted into the 36th slot 11 is connected to the second neutral point 12b. The second U-phase coil 8Ub at the 33rd location to the second U-phase coil 8Ub at the 64th location constitute the second star connection circuit S2 (see FIG. 1).

Similarly, a connection is performed in order from the second V-phase coil 8Vb at the 33rd location inserted into the 27th slot 11 to the second V-phase coil 8Vb at the 64th location inserted to the 34th slot 11. In the second V-phase coil 8Vb at the 33rd location, the terminal portion on the side opposite to the second V-phase coil 8Vb at the 34th location inserted into the 20th slot 11 is connected to the second inverter circuit 4. In the second V-phase coil 8Vb at the 64th location, the terminal portion on the side opposite to the second V-phase coil 8Vb at the 63rd location inserted into the 40th slot 11 is connected to the second neutral point 12b. The second V-phase coil 8Vb at the 33rd location to the second V-phase coil 8Vb at the 64th location constitute the second star connection circuit S2 (see FIG. 1).

Further, a connection is performed in order from the second W-phase coil 8Wb at the 33rd location inserted into the 31st slot 11 to the second W-phase coil 8Wb at the 64th location inserted into the 38th slot 11. In the second W-phase coil 8Wb at the 33rd location, the terminal portion on the side opposite to the second W-phase coil 8Wb at the 34th location inserted into the 24th slot 11 is connected to the second inverter circuit 4. In the second W-phase coil 8Wb at the 64th location, the terminal portion on the side opposite to the second W-phase coil 8Wb at the 63rd location inserted into the 44th slot 11 is connected to the second neutral point 12b. The second W-phase coil 8Wb at the 33rd location to the second W-phase coil 8Wb at the 64th location constitute the second star connection circuit S2 (see FIG. 1).

### Third Modified Example

<Coil Arrangement Structure>

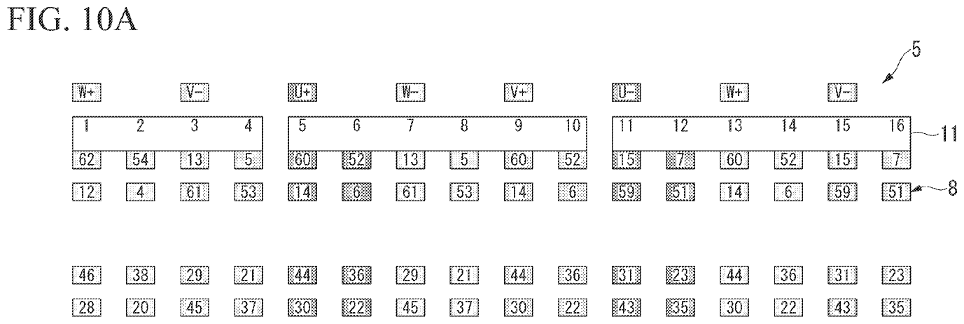

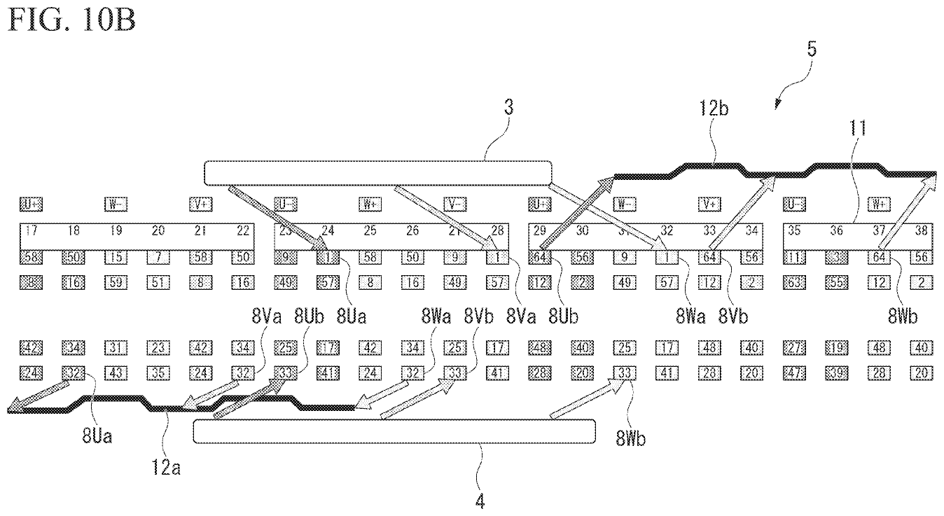

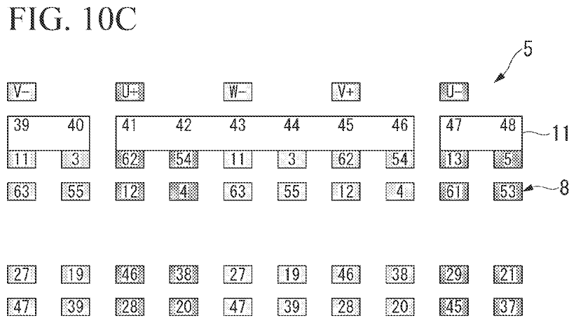

FIGS. 10A, 10B, and 10C are explanatory diagrams of the arrangement of each of the phase coils Ua to Wb in each slot 11 of a third modified example and are development views of the stator 5. FIGS. 10A to 10C correspond to FIGS. 4A to 4C described above.

As shown in FIGS. 10A to 10C, the arrangement structure of the coil 8 of the third modified example is a modified example of the wave winding structure of the second modified example. That is, the first U-phase coil 8Ua at the first location inserted into the 24th slot 11 is connected to the first U-phase coil 8Ua at the second location inserted into the 30th slot 11 with five slots 11 therebetween. The first U-phase coil 8Ua at the first location is disposed closer to the outermost peripheral portion (first layer) in four coils 8 inserted into the 24th slot 11. The first U-phase coil 8Ua at the second location is disposed at the second portion (second layer) from the outermost peripheral portion in four coils 8 inserted into the 30th slot 11.

This is connected to the remaining coils in order from the first U-phase coil 8Ua at the third location to the first U-phase coil 8Ua at the 32nd location. The terminal portion on the side opposite to the first U-phase coil 8Ua at the second location in the first U-phase coil 8Ua at the first location is connected to the first inverter circuit 3. In the first U-phase coil 8Ua at the 32nd location inserted into the 18th slot 11, the terminal portion on the side opposite to the first U-phase coil 8Ua at the 31st location inserted into the 11th slot 11 is connected to the first neutral point 12a. The first U-phase coil 8Ua at the first location to the first U-phase coil 8Ua at the 32nd location constitute the first star connection circuit S1 (see FIG. 1).

Similarly, a connection is performed in order from the first V-phase coil 8Va at the first location inserted into the 28th slot 11 to the first V-phase coil 8Va at the 32nd location inserted into the 22nd slot 11. In the first V-phase coil 8Va at the first location, the terminal portion on the side opposite to the first V-phase coil 8Va at the second location inserted into the 34th slot 11 is connected to the first inverter circuit 3. In the first V-phase coil 8Va at the 32nd location, the terminal portion on the side opposite to the first V-phase coil 8Va at the 31st location inserted into the 15th slot 11 is connected to the first neutral point 12a. The first V-phase coil 8Va at the first location to the first V-phase coil 8Va at the 32nd location constitute the first star connection circuit S1 (see FIG. 1).

Further, a connection is performed in order from the first W-phase coil 8Wa at the first location inserted into the 32nd slot 11 to the first W-phase coil 8Wa at the 32nd location inserted into the 26th slot 11. In the first W-phase coil 8Wa at the first location, the terminal portion on the side opposite to the first W-phase coil 8Wa at the second location inserted into the 38th slot 11 is connected to the first inverter circuit 3. In the first W-phase coil 8Wa at the 32nd location, the terminal portion on the side opposite to the first W-phase coil 8Wa at the 31st location inserted into the 19th slot 11 is connected to the first neutral point 12a. The first W-phase coil 8Wa at the first location to the first W-phase coil 8Wa at the 32nd location constitute the first star connection circuit S1 (see FIG. 1).

On the other hand, the second U-phase coil 8Ub at the 33rd location inserted into the 23rd slot 11 is connected to the second U-phase coil 8Ub at the 34th location inserted into the 18th slot 11 with four slots 11 therebetween. The second U-phase coil 8Ub at the 33rd location is disposed closer to the innermost peripheral portion (fourth layer) in four coils 8 inserted into the 23rd slot 11. The second U-phase coil 8Ub at the 34th location is disposed at the third portion (third layer) from the outermost peripheral portion in four coils 8 inserted into the 18th slot 11.

This is connected to the remaining coils in order from the second U-phase coil 8Ub at the 35th location to the second U-phase coil 8Ub at the 64th location. The terminal portion on the side opposite to the second U-phase coil 8Ub at the 34th location in the second U-phase coil 8Ub at the 33rd location is connected to the second inverter circuit 4. In the second U-phase coil 8Ub at the 64th location inserted into the 29th slot 11, the terminal portion on the side opposite to the second U-phase coil 8Ub at the 63rd location inserted into the 35th slot 11 is connected to the second neutral point 12b. The second U-phase coil 8Ub at the 33rd location to the second U-phase coil 8Ub at the 64th location constitute the second star connection circuit S2 (see FIG. 1).

Similarly, a connection is performed in order from the second V-phase coil 8Vb at the 33rd location inserted into the 27th slot 11 to the second V-phase coil 8Vb at the 64th location inserted into the 33rd slot 11. In the second V-phase coil 8Vb at the 33rd location, the terminal portion on the side opposite to the second V-phase coil 8Vb at the 34th location inserted into the 22nd slot 11 is connected to the second inverter circuit 4. In the second V-phase coil 8Vb at the 64th location, the terminal portion on the side opposite to the second V-phase coil 8Vb at the 63rd location inserted into the slot 11 at the 39th location is connected to the second neutral point 12b. The second V-phase coil 8Vb at the 33rd location to the second V-phase coil 8Vb at the 64th location constitute the second star connection circuit S2 (see FIG. 1).

Further, a connection is performed in order from the second W-phase coil 8Wb at the 33rd location inserted into the 31st slot 11 to the second W-phase coil 8Wb at the 64th location inserted into the 37th slot 11. In the second W-phase coil 8Wb at the 33rd location, the terminal portion on the side opposite to the second W-phase coil 8Wb at the 34th location inserted into the 26th slot 11 is connected to the second inverter circuit 4. In the second W-phase coil 8Wb at the 64th location, the terminal portion on the side opposite to the second W-phase coil 8Wb at the 63rd location inserted into the 43rd slot 11 is connected to the second neutral point 12b. The second W-phase coil 8Wb at the 33rd location to the second W-phase coil 8Wb at the 64th location constitute the second star connection circuit S2 (see FIG. 1).

In addition, the present invention is not limited to the above-described embodiment and modified examples, and includes various modifications to the above-described embodiment without departing from the scope of the present invention.

For example, in the above-described embodiment, the rotary electric device 1 has been described as one mounted on, for example, a vehicle such as an electric vehicle. However, the present invention is not limited thereto and the rotary electric device 1 can be used in various electric devices.

In the above-described embodiment and modified examples, the motor 2 has been described such that the number of magnetic poles of the rotor 6 is eight and the number of the slots 11 of the stator 5 is forty eight. However, the present invention is not limited thereto and the number of the magnetic poles or the number of the slots 11 can be arbitrarily set.

In the above-described embodiment and modified examples, a case in which two coil pairs 80U to 80W are arranged in each slot 11 has been described. However, the present invention is not limited thereto and at least one coil pair 80U to 80W may be disposed in at least one slot 11. Since at least one coil pair 80U to 80W exists, it is possible to reduce the harmonic component and to reduce the vibration (torque ripple) of the motor 2.

Here, at least one slot 11 can preferably be a common mode coil slot. At least two coil pairs 80U to 80W can preferably be arranged in the common mode coil slot. When two or more coil pairs 80U to 80W of the same phase are arranged in one slot 11, the first phase coils 8Ua to 8Wa and the second phase coils 8Ub to 8Wb can preferably be arranged alternately. In addition, common mode coil slots can preferably be located every other slot. With such a configuration, it is possible to more reliably reduce the harmonic component and to reduce the vibration (torque ripple) of the motor 2.

In the above-described embodiment and modified examples, a case in which four coils 8 are inserted into one slot 11 has been described. However, the present invention is not limited thereto and four or more coils 8 may be inserted into one slot 11. Even in such a case, at least one coil pair 80U to 80W may be disposed in at least one slot 11.

What is claimed is:

1. A rotary electric device comprising:
a rotary electric machine; and
a first inverter circuit and a second inverter circuit which control a driving of the rotary electric machine,
wherein the driving of the rotary electric machine is controlled by setting a phase of a carrier frequency of the first inverter circuit and a phase of a carrier frequency of the second inverter circuit as opposite phases,
wherein the rotary electric machine includes
a stator which includes a plurality of slots,
a plurality of coils each of which is inserted into each of the plurality of slots, and
a rotor which is provided to be rotatable relative to the stator,
wherein in the plurality of coils, one first coil connected to the first inverter circuit and one second coil connected to the second inverter circuit constitute one coil pair, and
wherein at least one coil pair is disposed in one of the plurality of slots.

2. The rotary electric device according to claim 1,
wherein the plurality of slots have a common mode coil slot in which only the coil pair of the same phase is disposed.

3. The rotary electric device according to claim 2,
wherein at least two coil pairs are arranged in the common mode coil slot, and the first coil and the second coil are alternately arranged.

4. The rotary electric device according to claim 3,
wherein the common mode coil slot is arranged every other slot.
